(19) United States
(12) Patent Application Publication
(10) Pub. No.: US 2009/0061814 A1
(43) Pub. Date: Mar. 5, 2009

(54) COMMUNICATION DEVICE AND MANAGEMENT APPARATUS THEREOF

(75) Inventor: Osamu HAMAUE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/189,422

(22) Filed: Aug. 11, 2008

Related U.S. Application Data
(63) Continuation of application No. PCT/JP2006/302445, filed on Feb. 13, 2006.

(51) Int. Cl. H04M 11/00

(52) U.S. Cl. 455/405

(57) ABSTRACT

A communication device (for instance, a portable terminal device) uses a recording medium (UIM) storing specific user information. The communication device is provided with a processing unit (CPU) for acquiring the user information from the recording medium, a registration unit (UIM information registration area) for registering the user information acquired by the processing unit by being related to device identification information for identifying the communication device, and a transmission unit (wireless communication unit) for transmitting the user information and the device identification information to a specific opposite party. From such structure, the user information acquired from the recording medium and the device information of the communication device itself are related and managed.

### CROSS-REFERENCE TO RELATED APPLICATIONS

This application is a continuation of International Application No. PCT/JP2006/302445, filed on Feb. 13, 2006, now pending, herein incorporated by reference.

### BACKGROUND OF THE INVENTION

1. Field of the Invention

The present invention relates to management of using a communication device such as a portable terminal device able to communicate by equipping with a recording medium such as a UIM (User Identify Module) card and SIM (Subscriber Identify Module) card that record subscriber information. Specifically, the present invention relates to a communication device whose security function such as prevention of abuse by a person except a subscriber is enhanced, management method thereof, management program thereof, management apparatus thereof, recording medium, communication management system and circuit device.

2. Description of the Related Art

A portable terminal device is an example of a communication device that can be used with equipment of a recording medium such as an SIM and UIM. The portable terminal device can be used by a person except a subscriber by replacement of a recording medium although usability is limited according to a recording medium.

Concerning such portable terminal device using a recording medium, there are techniques such as; when contents are received, storage of the contents is permitted on condition that UIMID of a UIM equipped with a device coincides with registered UIMID (Japanese Patent Application Laid-open Publication No. 2004-70727 (paragraph Nos. 0078, 0080, FIGS. 2, 4, etc.)); and a personal authentication system that makes an opposite party confirm identity of a sender by sending an identification code stored in an attachable UIM and identification information stored in a device (Japanese Patent Application Laid-open Publication No. 2004-259220(paragraph No. 0033, FIG. 3, etc.)).

Concerning a communication device that can be used with equipment of a recording medium such as an SIM and UIM, an owner of the communication device cannot specify the fact of abuse of the device resulting from loss or theft.

Concerning a portable terminal device, abuse cannot be prevented if outgoing suppression is canceled by decoding a password although the outgoing suppression is set by the password.

The technique described in JP2004-70727A merely permits reception of contents on condition of coinciding UIMID. JP2004-70727A cannot stop abuse. The technique described in JP2004-259220A merely makes an opposite party confirm identity of a sender. JP2004-259220A cannot stop abuse, either. These techniques cannot prevent abuse, and by using the techniques, an administrator or owner of a communication device such as a cellular phone cannot know abuse thereof. Concerning such problems, there is no disclosure or suggestion in JP2004-70727A and JP2004-259220A, and is no disclosure or suggestion to solve the problems.

### SUMMARY OF THE INVENTION

An object of the present invention relates to a communication device to communicate by equipping with a recording medium storing a specific user information, and is to enhance a function for preventing abuse.

Another object of the present invention relates to a communication device to communicate by equipping with a recording medium storing a specific user information, and is to enable to notify information on use such as abuse to a specific opposite party.

To achieve the above objects, a first aspect of the present invention there is provided a communication device that uses a recording medium storing specific user information, the communication device comprising: a processing unit that acquires the user information from the recording medium; a registration unit that registers the user information acquired by the processing unit by being related to device identification information identifying the communication device; and a transmission unit that transmits the user information and the device identification information to a specific opposite party. According to such structure, since user information obtained from a recording medium and device identification information that a communication device itself has are related and managed, the above objects can be achieved by the above structure with using the information.

To achieve the above objects, a second aspect of the present invention there is provided a communication device that uses a recording medium storing specific user information, the communication device comprising: a registration unit that registers the user information acquired from the recording medium; a determination unit that determines whether user information acquired from a recording medium and the user information in the registration unit coincide or not; and a transmission unit that, if the determination unit determines that user information is different, transmits information on use of a recording medium storing different user information to a specific opposite party. From such structure, the above objects can be achieved, too.

To achieve the above objects, in the above communication device, the information on use may comprise one or a plurality of device identification information, user information in the registration unit, utilization area information or user information in a replaced recording medium. The above objects can be achieved by using such information on use.

To achieve the above objects, the above communication device may comprise a reception unit that receives function suppression information notified from an outside; and a processing unit that suppresses a function of the communication device in accordance with the function suppression information. From such structure, abuse of a communication device is prevented.

To achieve the above objects, a third aspect of the present invention there is provided a communication device that uses a recording medium storing specific user information, the communication device comprising: a registration unit that registers the user information acquired from the recording medium; and a processing unit that permits modification of registered contents in the registration unit if user information acquired from a recording medium and the user information in the registration unit coincide. According to such structure, setting contents of a communication device can be secured.

To achieve the above objects, a fourth aspect of the present invention there is provided a communication device that uses a recording medium storing specific user information, the communication device comprising: a registration unit registers the user information acquired from the recording medium; and a processing unit that determines whether user information acquired from a recording medium and the user information in the registration unit coincide or not, and that, if user information is different, suppresses a function of the communication device. From such structure, abuse of a communication device can be prevented.

To achieve the above objects, a fifth aspect of the present invention there is provided a management method of a communication device that uses a recording medium storing specific user information, the method comprising: acquiring user information from the recording medium; registering the acquired user information in connection with device identification information of the communication device; and transmitting the user information and the device identification information to a specific opposite party. According to such structure, an opposite party receiving notification of user information and device identification information can manage a communication device.

To achieve the above objects, a sixth aspect of the present invention there is provided a management method of a communication device that uses a recording medium storing specific user information, the method comprising: registering the user information acquired from the recording medium in a registration unit; determining whether user information acquired from the recording medium and the user information in the registration unit coincide or not when the recording medium is equipped; and transmitting, if it is determined that user information is different, information on use of a recording medium storing different user information to a specific opposite party. According to such structure, information on use can be used for identifying a communication device concerning abuse.

To achieve the above objects, a seventh aspect of the present invention there is provided a management method of a communication device that uses a recording medium storing specific user information, the method comprising: registering the user information acquired from the recording medium in a registration unit; determining whether user information acquired from the recording medium and the user information in the registration unit coincide or not when the recording medium is equipped; and suppressing a function of the communication device if it is determined that user information is different. From such structure, abuse of a communication device can be prevented, too.

To achieve the above objects, an eighth aspect of the present invention there is provided a management program of a communication device that uses a recording medium storing specific user information and is executed by a computer, the program comprises the steps of: acquiring the user information from the recording medium if the recording medium is equipped; registering the acquired user information in connection with device identification information of the communication device; and transmitting the user information and the device identification information to a specific opposite party. From such structure, the above objects can be achieved, too.

To achieve the above objects, a ninth aspect of the present invention there is provided a management program of a communication device that uses a recording medium storing specific user information and is executed by a computer, the program comprises the steps of: registering the user information acquired from the recording medium in a registration unit; determining whether user information acquired from a recording medium and the user information in the registration unit coincide or not; and transmitting, if it is determined that user information is different, information on use of a recording medium storing different user information to a specific opposite party. From such structure, the above objects can be achieved, too.

To achieve the above objects, a tenth aspect of the present invention there is provided a management program of a communication device that uses a recording medium storing specific user information and is executed by a computer, the program comprises the steps of: registering the user information acquired from the recording medium in a registration unit; determining whether user information acquired from a recording medium and the user information in the registration unit coincide or not; and suppressing a function of the communication device if it is determined that user information is different. From such structure, abuse of a communication device can be prevented, too.

To achieve the above objects, an eleventh aspect of the present invention there is provided a recording medium that is used for a communication device, the recording medium comprising: a recording unit storing device identification information obtained from the communication device. According to such structure, a relationship between a communication device and recording medium equipped with the communication device can be recognized from a recording medium.

To achieve the above objects, a twelfth aspect of the present invention there is provided a management apparatus of a communication device that uses a recording medium storing specific user information, the management apparatus comprising: a communication unit that communicates with the communication device, and acquires device identification information identifying the communication device and the user information and; a first registration unit that registers the device identification information and user information acquired in the communication unit. According to such structure, since user information obtained from a recording medium and device identification information that a communication device itself has are related and managed, the above objects can be achieved by using the information.

To achieve the above objects, in the above management apparatus, by equipping with a recording medium storing user information different from the user information registered in the communication unit, information on use, which is notified from the communication device, may be obtained, and the information on use may be sent from the communication unit to a specific opposite party. Such structure can achieve the above objects, too.

To achieve the above objects, the above management apparatus may comprise a second registration unit that obtains and registers information on use, which is notified from the communication device able to communicate by equipping with a recording medium storing use information different from the user information registered in the communication unit, wherein the information on use registered in the registration unit is sent toward a specific notification requester from the communication unit. Such structure can achieve the above objects, too.

To achieve the above objects, in the above management apparatus, the information on use may comprise one or a plurality of device identification information, user information in the registration unit, utilization area information or user information in the replaced recording medium. Such structure can achieve the above objects, too.

To achieve the above objects, in the above management apparatus of the communication device, function suppression information may be sent from the communication unit to the communication device on the basis of a request from a specific request destination. From such structure, a security function against abuse of a communication device can be enhanced.

To achieve the above objects, a thirteenth aspect of the present invention there is provided a management method of a communication device that uses a recording medium storing specific user information, the method comprising:

communicating with the communication device, and acquiring device identification information identifying the communication device and the user information and; registering the acquired device identification information and user information. From such structure, the above objects can be achieved, too.

To achieve the above objects, the above management method of the communication device may comprise obtaining information on use, which is notified from the communication device by equipping with a recording medium storing user information different from the user information registered in the communication device; and notifying the information on use to a specific opposite party. According to such structure, an opposite party to whom information is notified can obtain information such as abuse, and the information can be used for identification of abuse and a user thereof.

To achieve the above objects, the above management method of the communication device may comprise registering information on use, which is notified from the communication device able to communicate by equipping with a recording medium storing user information different from the user information registered in the communication device; and notifying the information on use toward a specific notification requester.

To achieve the above objects, in the above management method of the communication device, function suppression information may be sent toward the communication device on the basis of a request from a specific request destination.

To achieve the above objects, a fourteenth aspect of the present invention there is provided a management program of a communication device that uses a recording medium storing specific user information and is executed by a computer, the program comprises the steps of: communicating with the communication device, and acquiring device identification information identifying the communication device and the user information and; registering the acquired device identification information and the user information. From such structure, the above objects can be achieved, too.

To achieve the above objects, the management program of the communication device may comprise obtaining information on use, which is notified from the communication device using a recording medium storing user information different from the user information registered in the communication device, and sending the information on use to a specific opposite party.

To achieve the above objects, the above management program of a communication device may comprise registering information on use, which is notified from the communication device using a recording medium storing user information different from the user information registered in the communication device; and notifying the information on use toward a specific notification requester.

To achieve the above objects, the above management program of the communication device may comprise transmitting function suppression information toward the communication device on the basis of a request from a specific request destination.

To achieve the above objects, a fifteenth aspect of the present invention there is provided a communication management system that uses a recording medium storing specific user information, the system comprising: a communication device that transmits the user information acquired from the recording medium and device identification information identifying the communication device; and a management server that obtains the user information and device identification information transmitted from the communication device to register them; wherein the user information is related to the device identification information and managed. From such structure, the above objects can be achieved, too.

To achieve the above objects, a sixteenth aspect of the present invention there is provided a circuit device that uses a recording medium storing specific user information, the circuit device comprising: a processing unit acquiring the user information from the recording medium; a registration unit that relates the user information acquired by the processing unit to device identification information of a communication device and is registered; and a transmission unit that transmits the user information and device identification information to a specific opposite party. From such structure, the above objects can be achieved, too.

To achieve the above objects, a seventeenth aspect of the present invention there is provided a circuit device that uses a recording medium storing specific user information, the circuit device comprising: a registration unit that registers the user information acquired from the recording medium; a determination unit that determines whether user information acquired from a recording medium and the user information in the registration unit coincide; and a transmission unit that, if the determination unit determines that user information is different, transmits information on use of a recording medium storing different user information to a specific opposite party. From such structure, the above objects can be achieved, too.

To achieve the above objects, an eighteenth aspect of the present invention there is provided a circuit device that uses a recording medium storing specific user information, the circuit device comprising: a registration unit that registers the user information acquired from the recording medium; and a processing unit that permits modification of registered contents in the registration unit if user information acquired from a recording medium and the user information in the registration unit coincide. From such structure, the above objects can be achieved, too.

To achieve the above objects, a nineteenth aspect of the present invention there is provided a circuit device that uses a recording medium storing specific user information, the circuit device comprising: a registration unit that registers the user information acquired from the recording medium; and a processing unit that determines whether user information acquired from a recording medium and the user information in the registration unit coincide or not, and if user information is different, suppresses a function of the communication device. From such structure, the above objects can be achieved, too.

The features and advantages of the present invention are as follows.

(1) Device identification information that identifies a communication device and specific user information in a recording medium are related, and the communication device and recording medium can be integrally managed.

(2) According to the structure that by replacement to a recording medium that stores user information different from specific user information registered in a communication device, information on use of the communication device is sent to a specific opposite party from the communication device, conditions on use such as abuse can be known from the information on use.

(3) According to the structure that setting information of a communication device can be modified in case a recording medium storing user information which coincides with user information registered in the communication device is equipped, abuse by replacement of a recording medium storing different user information can be prevented.

(4) According to the structure that a function of a communication device is suppressed in case of replacement to a recording medium storing user information different from user information registered in the communication device, abuse of the communication device can be prevented.

Other objects, features and advantages of the present invention are more clearly understood by referring to the attached drawings and each of the embodiments.

### BRIEF DESCRIPTION OF THE DRAWINGS

FIG. 1 depicts an example of a communication management system;

FIG. 2 depicts a portable terminal device that is an example of a communication device;

FIG. 3 depicts an exemplified structure of a portable terminal device;

FIG. 4 depicts an exemplified structure of a UIM that is an example of a recording medium;

FIG. 5 depicts an exemplified structure of a management server that is an example of a communication management apparatus;

FIG. 6 depicts an example of operation of a portable terminal device and management server;

FIG. 7 is a flowchart showing processing of a portable terminal device;

FIG. 8 is a flowchart showing processing of a management server;

FIG. 9 depicts exchange between a valid user and management server in abuse of a portable terminal device;

FIG. 10 depicts an example of operation of a portable terminal device and management server in abuse;

FIG. 11 depicts an example of operation of a portable terminal device and management server in abuse;

FIG. 12 is a flowchart showing an example of processing of a portable terminal device when a UIM is replaced;

FIG. 13 is a flowchart showing an example of processing of a management server in abuse of a portable terminal device;

FIG. 14 is a flowchart showing an example of processing of information on loss of a management server;

FIG. 15 is a flowchart showing an example of processing of a management server in abuse of a portable terminal device;

FIG. 16 depicts an example of a processing sequence concerning abuse;

FIG. 17 depicts an example of a processing sequence of function suppression or release thereof in a portable terminal device;

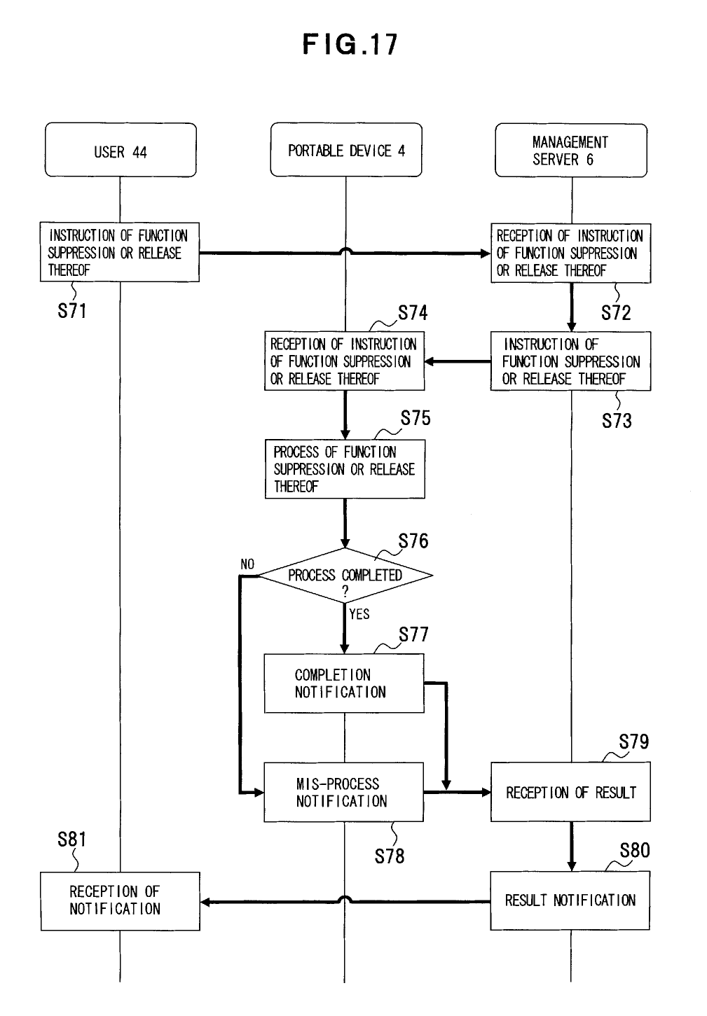

FIG. 18 depicts an example of operation of setting modification;

FIG. 19 is a flowchart showing a process of setting modification;

FIG. 20 depicts an example of a circuit device;

FIG. 21 depicts a PDA that is an example of another communication device; and

FIG. 22 depicts a personal computer that is an example of another communication device.

### DETAILED DESCRIPTION OF THE PREFERRED EMBODIMENTS

### First Embodiment

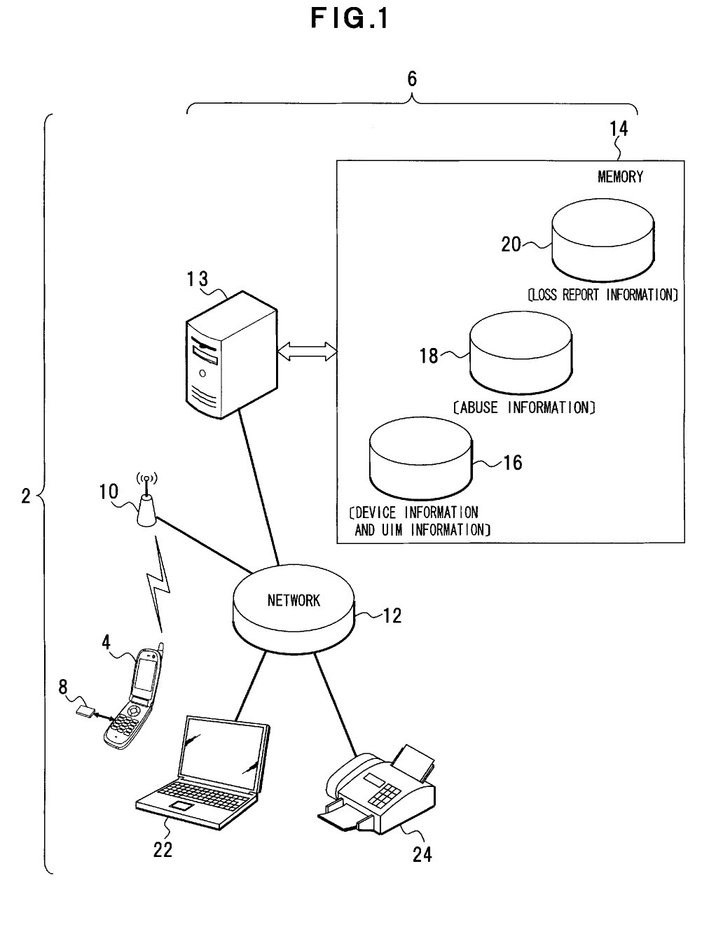

A first embodiment of the present invention will be described with reference to FIG. 1. FIG. 1 depicts an example of a communication management system according to the present invention.

This communication management system 2 is an example of a management system of a communication device of the present invention. The communication management system 2 includes a portable terminal device 4 as an example of a communication device according to the present invention, and a management server 6 as an example of a communication management apparatus according to the present invention. The portable terminal device 4 is a communication device able to communicate by equipment of a recording medium such as a UIM (User Identify Module) 8 storing specific user information. The UIM 8 stores user information representative of a specific user such as a subscriber. The user information is, for example, UIM information such as a UIM number. The portable terminal device 4 has device identification information (hereinafter referred to as “device information”) such as a serial number used for identifying the device itself.

The portable terminal device 4 can be used for communication with other communication devices by radio via a base station 10. The base station 10 is connected to a network 12. The network 12 is a public network such as the Internet.

The management server 6 is disposed at a communication manager such as a carrier, and is connected to the network 12. The management server 6 can be used for communication with the portable terminal device 4 via the network 12 and base station 10. The management server 6 is a computer system including a server computer 13, and includes a memory 14 storing information such as the above described UIM information and device information that are sent from the portable terminal device 4. The memory 14 is, for example, composed of a recording medium such as a hard disc device.

A plurality of registration areas are set in the memory 14, such as a device information and UIM information registration area 16 as a first registration unit, an abuse information registration area 18 as a second registration unit and a loss information registration area 20 as a third registration unit. In the registration area 16, device information and UIM information are related and registered as management information of the portable terminal device 4. In the registration area 18, abuse information of the portable terminal device 4 is registered. In the registration area 20, loss notification information is registered as notified loss report information of the portable terminal device 4.

To the network 12, a personal computer (PC) 22 and a facsimile apparatus 24 are connected as a communication device for notifying loss, etc. If loss is notified to the management server 6 via these devices, loss report information is registered in the loss information registration area 20 by personal processing or electronic information processing. In this case, another portable terminal device may be used as another means for notification. The loss report information registered in the registration area 20 can be browsed by the PC 22, etc. through the network 12. Thus, abuse, etc. can be known.

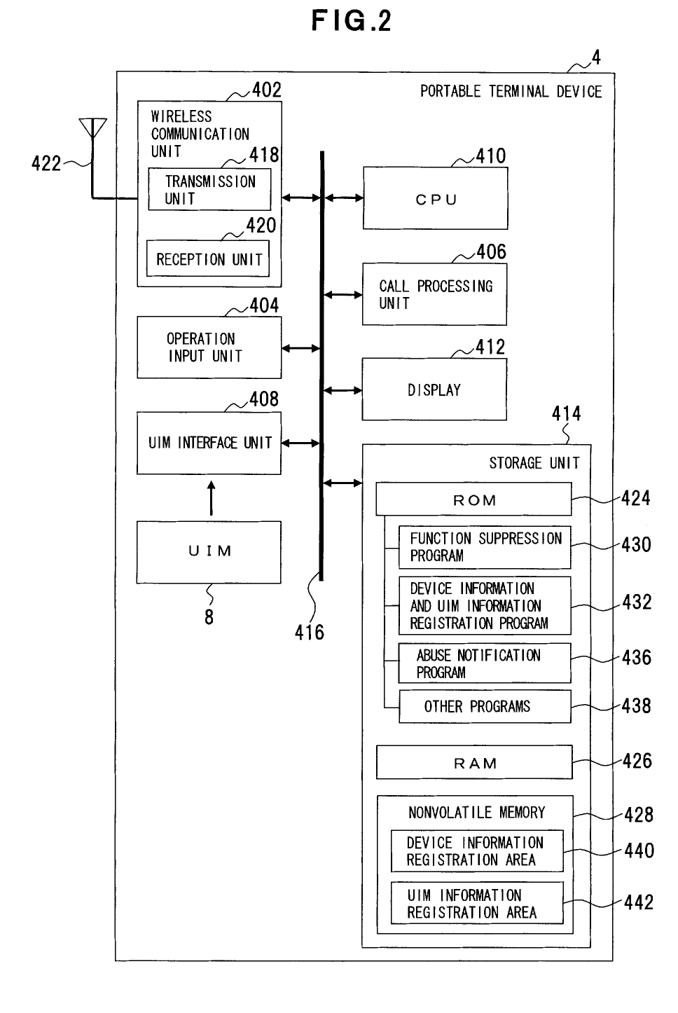

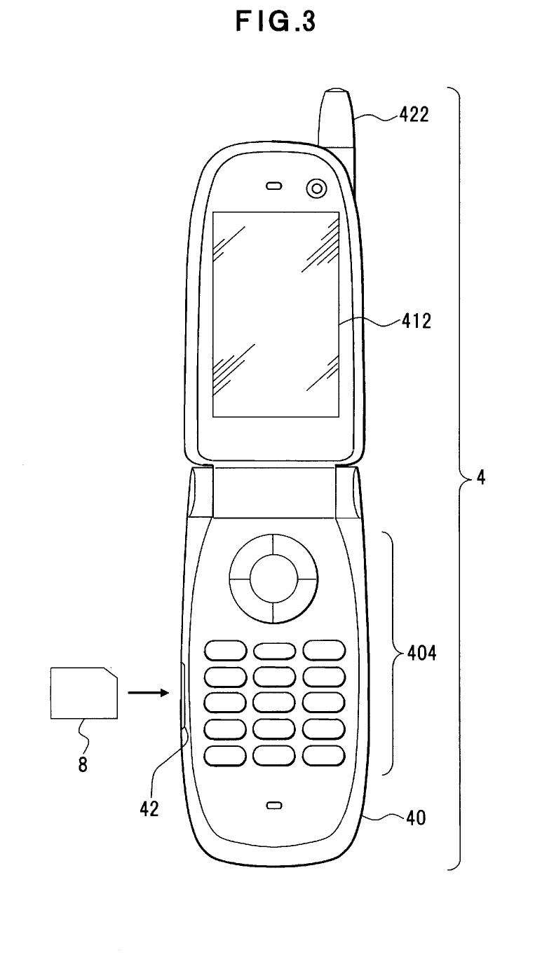

A communication device according to the present invention will be described with reference to FIGS. 2 and 3. FIG. 2 depicts an example of a portable terminal device and FIG. 3 depicts an aspect of a portable terminal device. The depicted communication device is one example, and does not limit the present invention. Same reference numerals are used in FIGS. 2 and 3 for the same constituents in FIG. 1.

This portable terminal device 4 includes a wireless communication unit 402, an operation input unit 404, a call processing unit 406, a UIM interface unit 408, a CPU (Central Processing Unit) 410, a display 412, a storage unit 414, etc. They are connected by a bus 416.

The wireless communication unit 402 has a transmission unit 418, a reception unit 420, an antenna 422, etc. On the basis of control by the CPU 410, the wireless communication unit 402 executes wireless communication with the base station 10. The transmission unit 418 generates a transmission signal by superimposing packet communication data and voice, etc. on a carrier wave, and sends the transmission signal to the base station 10 via the antenna 422. The reception unit 420 receives a wireless signal sent from the base station 10 via the antenna 422, and demodulates a signal such as data for packet communication and voice.

The operation input unit 404 is composed of a keyboard, etc., including a plurality of keys such as alphabetic keys, numeric keys, cursor input keys. The operation input unit 404 is used for input of literal information, etc. for CPU 410 and input of device information representative of the portable terminal device 4.

The call processing unit 406 includes a voice processing unit such as a microphone and speaker, and processes incoming and outgoing, etc. by control with CPU 410.

The UIM interface unit 408 is composed of a UIM equipment part, etc. disposed in a housing of the portable terminal device 4, and executes communication between the equipped UIM 8 and the CPU 410. The CPU 410 is a processing unit that executes various programs stored in the storage unit 414, controls each unit such as the wireless communication unit 402 via the bas 416. The control includes communication control, transmission control of device information and UIM information in new registration, a modification process of registration information, function suppression (locking operation) control of the portable terminal device 4, registration of device information, registration of UIM information, etc.

The display 412 is composed of an LCD (Liquid Crystal Display), etc. and performs display about control on a screen.

The storage unit 414 is composed of a ROM (Read-Only Memory) 424, a RAM (Random-Access Memory) 426, a nonvolatile memory 428, etc. The ROM 424 stores various programs such as a function suppression program 430, device information and UIM information registration program 432, abuse notification program 436 and other programs 438. In the nonvolatile memory 428, a device information registration area 440 and UIM information registration area 442 are set. In the registration area 440, the above described device information of the portable terminal device 4 is registered. In the registration area 442, UIM information is registered. The RAM 426 stores information in the middle of a process, etc.

The portable terminal device 4 includes, as shown in FIG. 3, an equipment part 42 by which the UIM 8 is equipped to a body of the device 40. By equipping with the UIM 8 with the equipment part 42, the UIM 8 and portable terminal device 4 can communicate with each other.

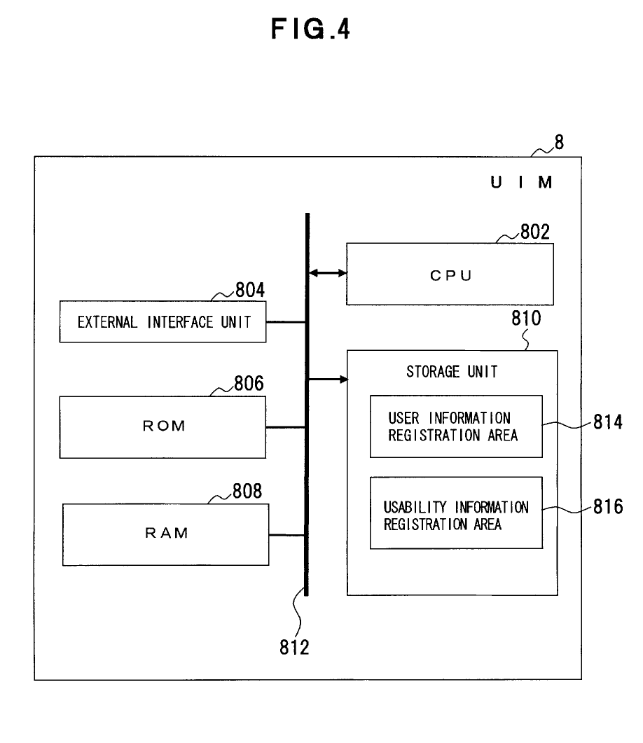

A recording medium used for a communication device of the present invention will be described with reference to FIG. 4. FIG. 4 is a block diagram showing an example of the UIM 8. The UIM 8 is one example of a recording medium used in a communication device. The UIM 8 does not limit the present invention.

The UIM 8 has a CPU 802, an external interface unit 804, a ROM 806, a RAM 808 and a writable storage unit 810, which are connected via a bus 812.

The CPU 802 executes a program stored in the ROM 806, and communicates with the portable terminal device 4 and performs control such as information writing to the storage unit 810. The external interface unit 804 communicates with the portable terminal device 4 by the CPU 802. A program and data, etc. for controlling the UIM 8 are stored in the ROM 806. Data in the middle of a process, etc. is temporarily stored in the RAM 808.

In the storage unit 810, a user information registration area 814 and usability information registration area 816 of the portable terminal device 4, etc. using the UIM 8, etc. are set. In the registration area 814, device information of the portable terminal device 4 and user information such as a user of the UIM 8 and telephone number are registered. In the registration area 816, for example a below described cancel key and expiration date are registered as device usability information.

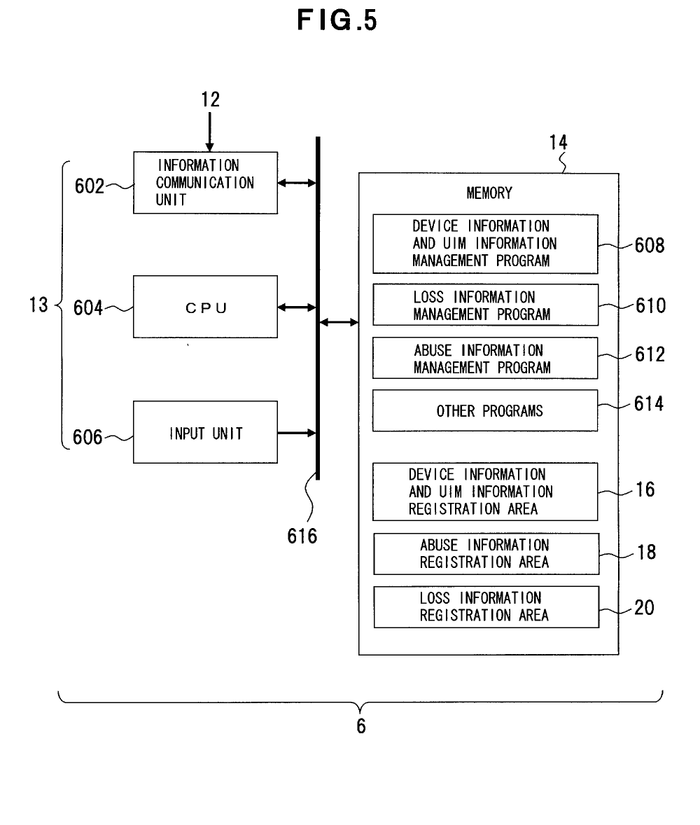

A communication management apparatus according to the present invention will be described with reference to FIG. 5. FIG. 5 depicts an exemplified structure of the management server 6. The depicted management server is one example, and does not limit a communication management apparatus of the present invention. Same reference numerals are used in FIG. 5 for the same constituents in FIG. 1.

This management server 6 is composed of the server computer 13 and the memory 14, etc. The management server 6 includes an information communication unit 602, a CPU 604, an input unit 606, etc. A hard disc device, etc. is used for the memory 14. The memory 14 stores a device information and UIM information management program 608, loss information management program 610, abuse information management program 612, other programs 614, etc. The device information and UIM information management program 608 receives notification of device information and UIM information from the portable terminal device 4, and processes registration thereof, etc. The loss information management program 610 performs registration process of notified loss report information, etc. The abuse information management program 612 performs registration process of abuse information such as an abuse history, etc.

The information communication unit 602 communicates with the portable terminal device 4, and sends and receives information to/from the base station 10 via the network 12. The CPU 604 executes various programs stored in the memory 14, and controls each unit such as the information communication unit 602 via a bus 616. The input unit 606 is composed of a keyboard, etc., and inputs information to the CPU 604.

Operation of the communication management system 2, portable terminal device 4 and management server 6 will be described.

a. Setting of Portable Terminal Device 4 and UIM 8

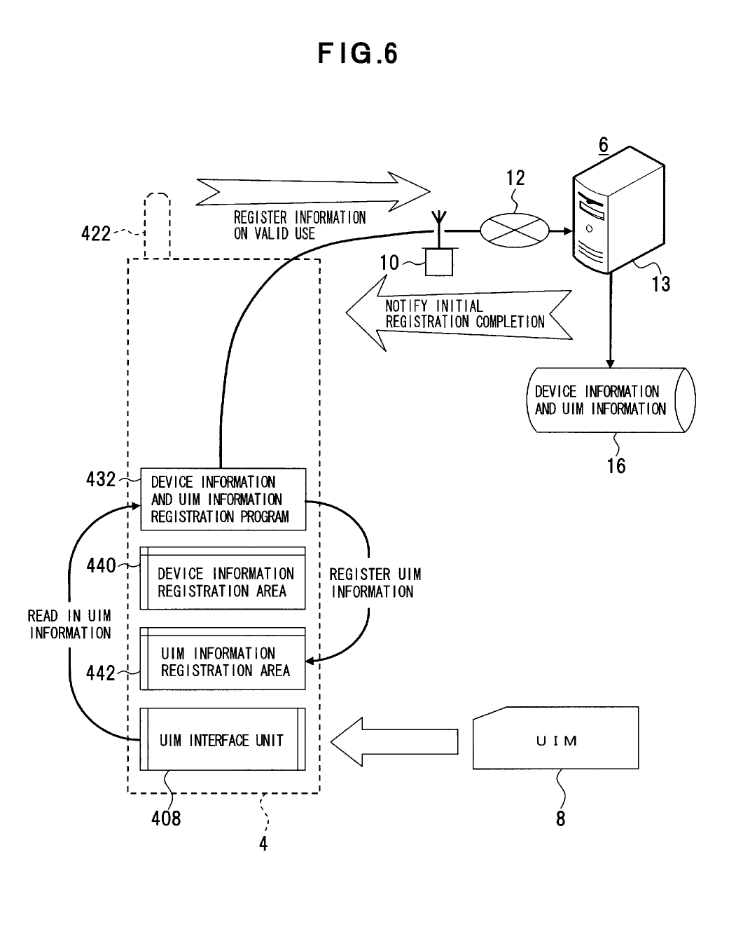

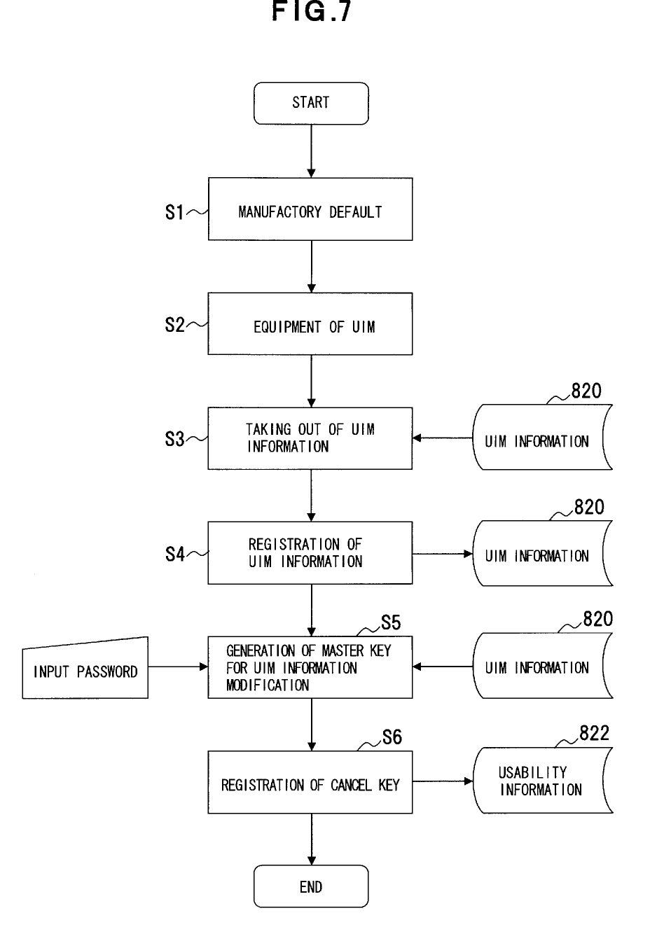

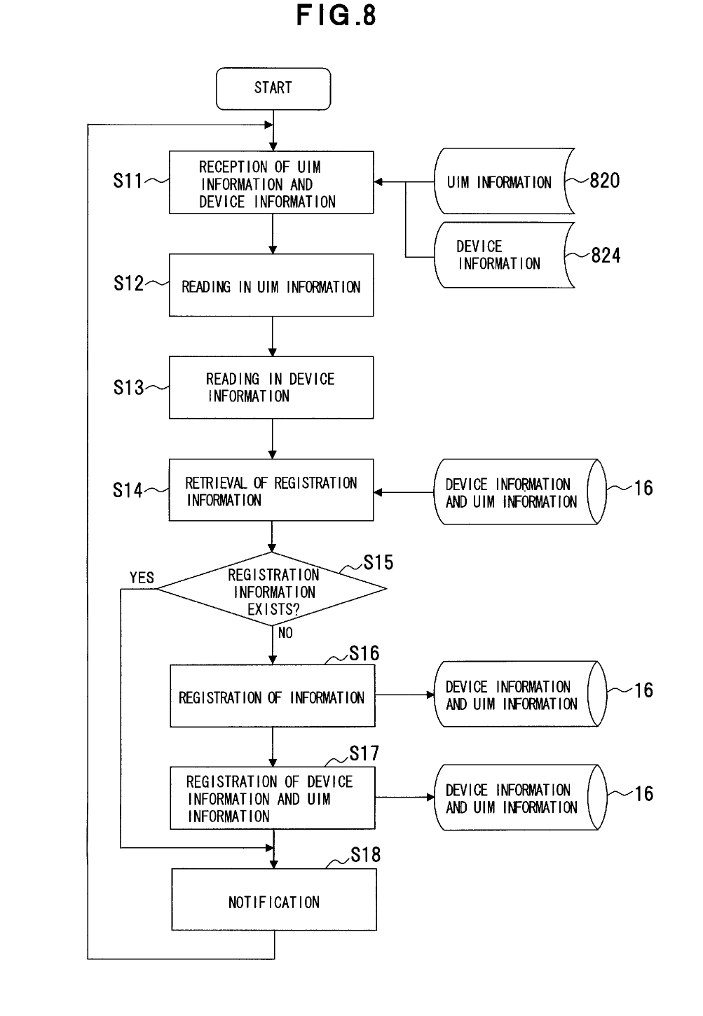

FIG. 6 depicts operation of an initial registration, FIG. 7 is a flowchart showing an initial setting operation of the portable terminal device 4 and FIG. 8 is a flowchart showing registration operation of UIM information and device information of the management server 6. Same reference numerals are used in FIGS. 6, 7 and 8 for the same constituents in FIGS. 1 and 2.

As shown in FIG. 6, an initial registration of the portable terminal device 4 is executed by equipping the portable terminal device 4 with the UIM 8 that is validly obtained by a user. The UIM interface unit 408 and a device information and UIM information registration program 432 of the portable terminal device 4 are used. UIM information is related to device information and is registered in the UIM information registration area 442 of the portable terminal device 4, and also registered in the device information and UIM information registration area 16 at the management server 6 side.

In an initial registration process of the portable terminal device 4 side, as shown in FIG. 7, if the portable terminal device 4 is in manufactory default (a state where UIM information does not exist) (step 1), the portable terminal device 4 is equipped with the UIM 8 (step S2). By the device information and UIM information registration program 432 being executed, information is taken out from the UIM 8 (step S3). From this, the UIM information 820 is taken out from the UIM 8 to the portable terminal device 4. The UIM information 820 is registered in the UIM information registration area 442 of the portable terminal device 4 (step S4). The UIM information 820 is related to device information that is identification information of the portable terminal device 4 in the device information registration area 440, and is registered. The processes S1-S4 are also applicable to the portable terminal device 4 that has not been equipped with the UIM 8 yet.

After registration of the UIM information 820, a master key for UIM information modification is generated (step S5). A password and the UIM information 820 are used for generation of the master key. The password is inputted by operation of ten keys, etc. on the operation input unit 404 in accordance with guide information displayed on a screen of the display 412.

After the master key for UIM information modification is generated, a cancel key is generated from the master key for UIM information modification. The cancel key is usability information 822. The cancel key is registered in the usability information registration area 816 of the UIM 8 (FIG. 4), and is also registered in the UIM information registration area 442 of the portable terminal device 4 (step S6). From this, the process of the initial setting is ended. That is, the cancel key is information relating device information to UIM information, and information representative of an expiration date of the cancel key, etc.

b. Registration Process of Management Server 6

As shown in FIG. 8, in a registration process of the management server 6, the UIM information 820 and device information 824 notified from the portable terminal device 4 are received (step S11). Reading in the UIM information 820 (step S12) and reading in device information 824 (step S13) are executed. Registration information of the device information and UIM information registration area 16 is retrieved (step S14). Whether the registration information exists is determined (step S15). If the registration information does not exist (NO at step S15), the information is registered in the device information and UIM information registration area 16 (step S16). In this case, the UIM information 820 is related to the device information 824 and is registered (step S17). If the registration information exists (YES at step S15), the registration process of the management server 6 is ended. Thus, double registration of the same information is avoided.

After the registration of the UIM information, registration completion notification is sent from the management server 6 to the portable terminal device 4 (step S18), and the registration process is ended. In the portable terminal device 4, the gist that the registration is done is displayed on the display 412 by reception of the registration notification. The portable terminal device 4 recognizes that itself is registered in the management server 6.

c. Processing Operation of Portable Terminal Device 4 and Management Server 6 in Replacement of UIM

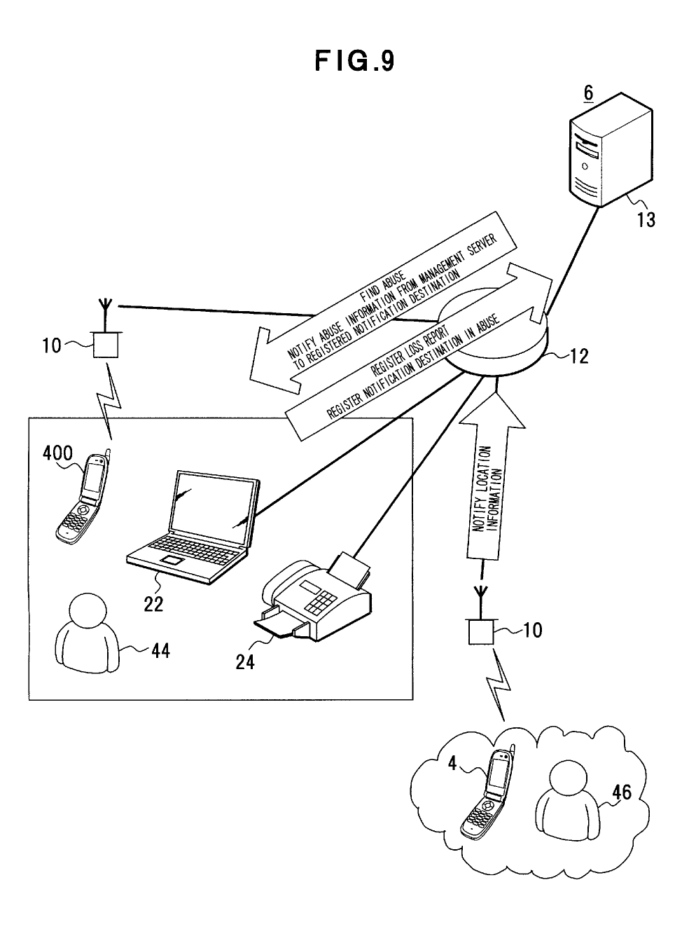

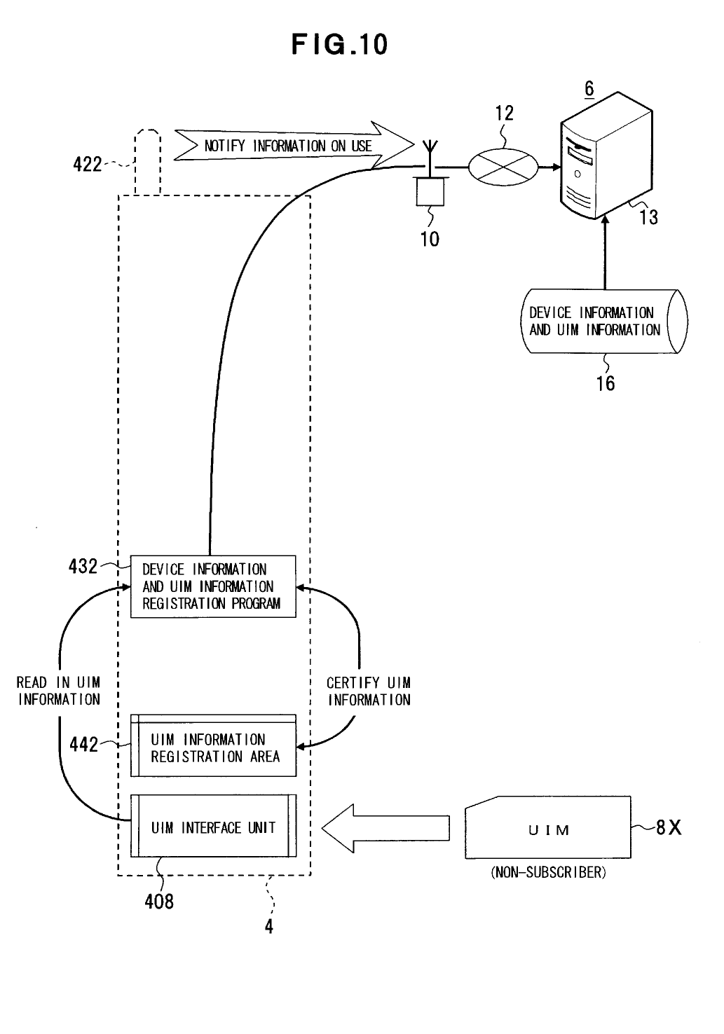

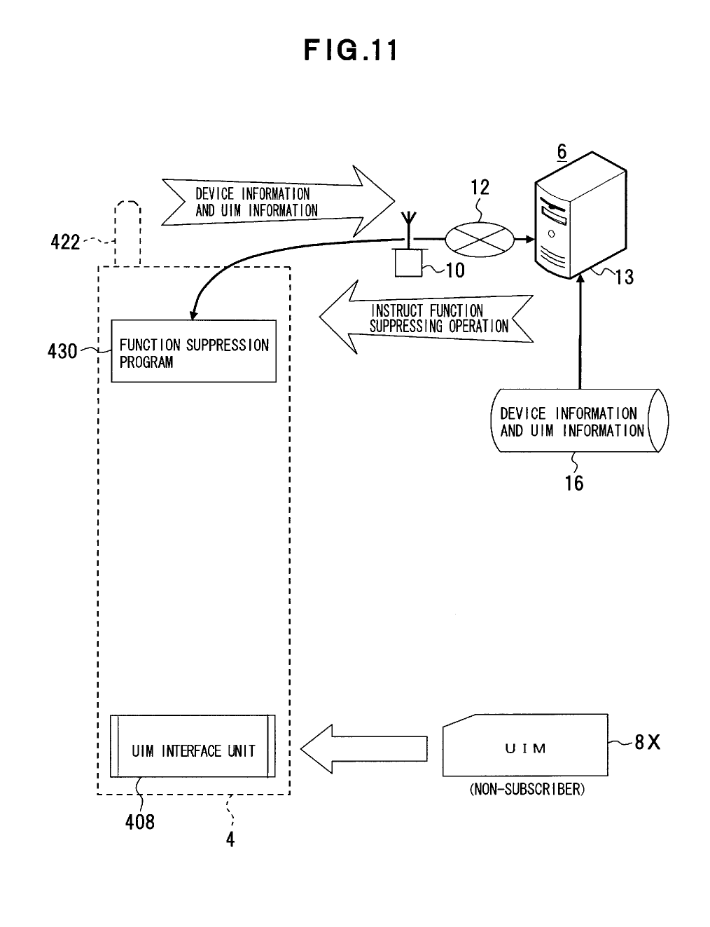

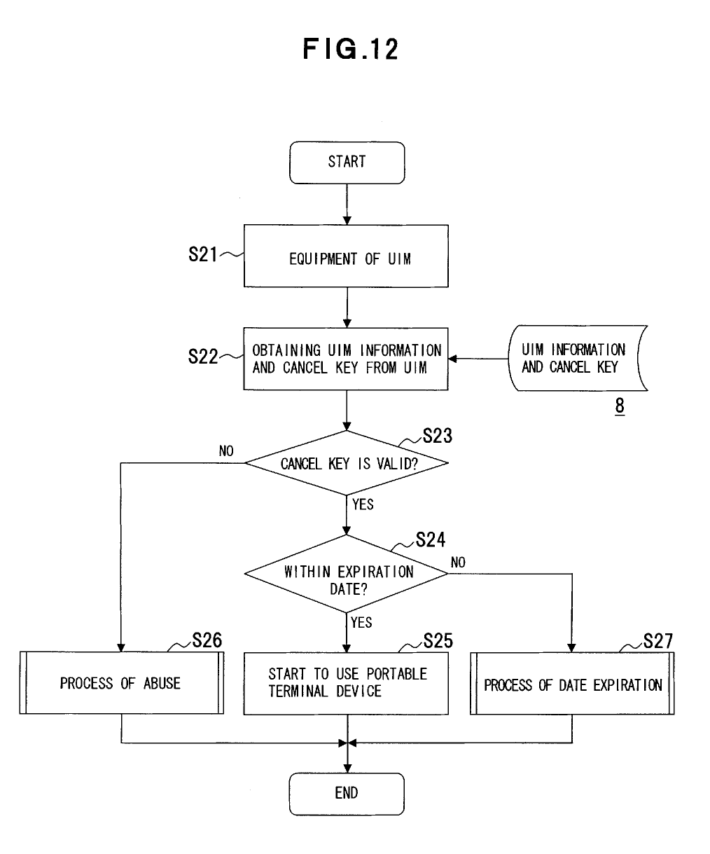

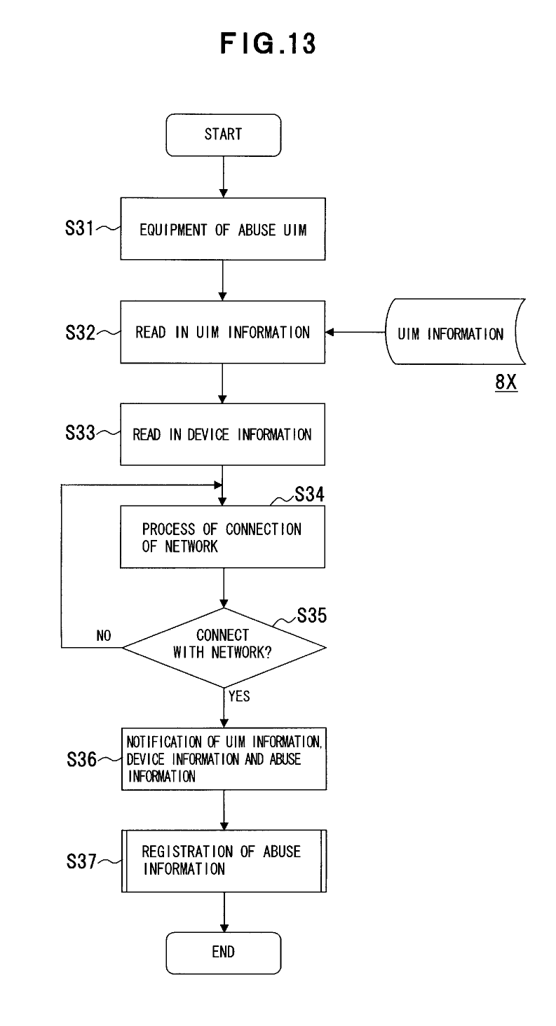

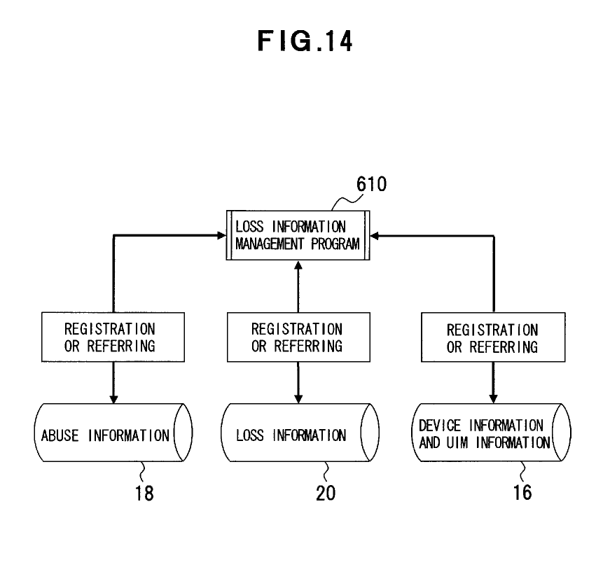

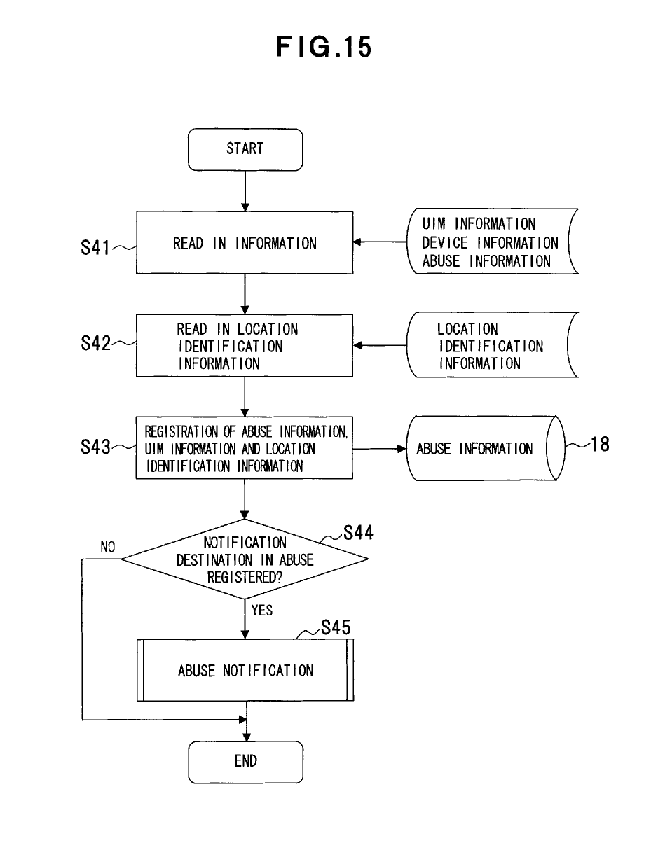

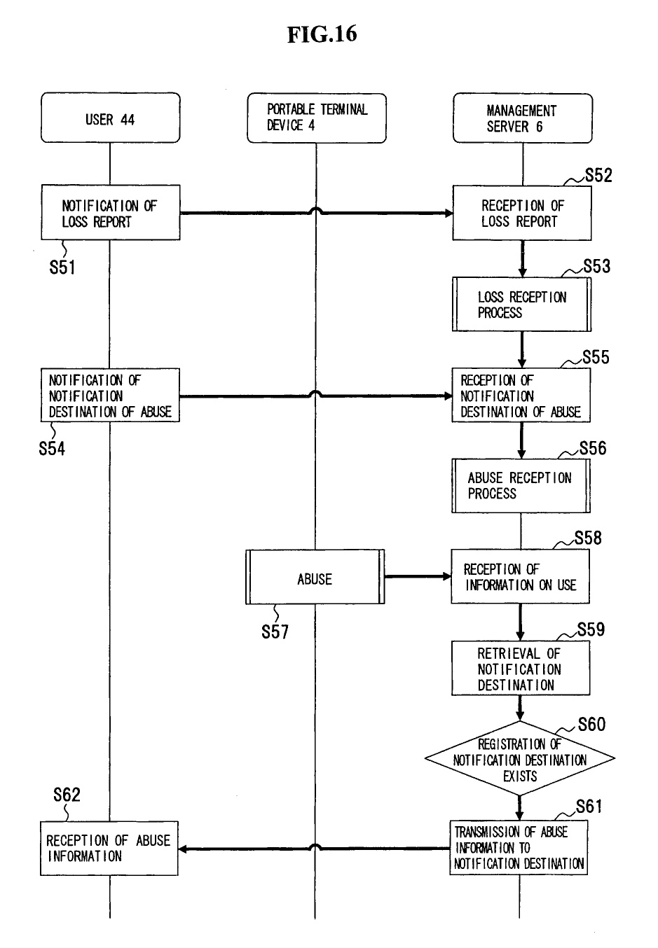

FIG. 9 depicts a processing summary in abuse, FIGS. 10 and 11 depict operation of the portable terminal device 4, FIGS. 12 and 13 are flowcharts showing processing operation of the portable terminal device 4, FIG. 14 depicts a relationship between a loss information management program and each piece of information, FIG. 15 is a flowchart showing a notification process in abuse and FIG. 16 depicts a processing sequence in abuse. Same reference numerals are used in FIGS. 9-16 for the same constituents in FIGS. 1 and 2.

In case the portable terminal device 4 is lost, as shown in FIG. 9, a user (a valid subscriber) 44 submits a loss report by using the PC 22 or facsimile apparatus 24 to the management server 6. The user 44 becomes a notification requester of information such as abuse. The PC 22 reports loss by e-mail, etc. The loss report is registered in the loss information registration area 20 by execution of the loss information management program 610.

Abuse such that the lost portable terminal device 4 is used by a user 46 except the subscriber (an abuser), turns out by the management server 6 receiving notification of device information, UIM information and location identification information from the portable terminal device 4 according to information sent from the portable terminal device 4.

If the abuse is confirmed, abuse information is notified from the management server 6 to another portable terminal device 400 that the user 44 registers in the management server 6. Abuse information represents the lost portable terminal device 4 having being used, a place where the portable terminal device 4 was used, etc. It may be done that an abuser is specified from UIM information used by the invalid user to be registered in the management server 6, and the registration is notified to the valid user side. In this case, it is possible to browse abuse information in the management server 6 by using the PC 22 to know the fact.

As shown in FIG. 10, such processing operation of the portable terminal device 4 concerning abuse is executed by the abuser (non-subscriber) equipping the portable terminal device 4 with a UIM 8X. The processing operation uses the UIM interface unit 408 of the portable terminal device 4 and the device information and UIM information registration program 432, and UIM information in the UIM information registration area 442. If the portable terminal device 4 communicates, information on use representative of abuse thereof is notified to the management server 6. In the management server 6, a loss report, device information and UIM information are referred, and a check of the notified UIM information is executed.

If the management server 6 determines that it is abuse of the lost portable terminal device 4, as shown in FIG. 11, start of function suppressing operation is notified to the portable terminal device 4. The function suppressing operation is executed by the function suppression program 430.

(Equipping or Replacing Operation of UIM)

As shown in FIG. 12, in the portable terminal device 4 where UIM information of the UIM 8 has been registered, if the other UIM 8 (FIG. 6) is equipped in the portable terminal device 4 (step S21), UIM information and a cancel key are obtained from the equipped UIM 8 (step S22), and whether the cancel key is valid is determined. (step S23). That is, whether the cancel key obtained from the UIM 8 coincides with the cancel key registered in the portable terminal device 4 side is determined. If the cancel key is valid (YES at step S23), whether an expiration date of the cancel key is effective is determined (step S24). If effective (YES at step S24), use of the portable terminal device 4 equipped with the UIM 8 can be started to use (step S25). If the cancel key is invalid (No at step S23), a process of abuse (step S26) is executed. If the expiration date of the cancel key is noneffective (NO at step S24), a process of date expiration (step S27) is executed.

(Process of Abuse of UIM)

As shown in FIG. 13, if the portable terminal device 4 is equipped with the UIM 8X (FIG. 10) of abuse (step S31), UIM information is read out from the UIM 8X (step S32), and device information of the portable terminal device 4 is read out (step S33). After such reading out of the information, connection of the network 12 is executed (step S34) and whether the network 12 is connected is determined (step S35). If the network 12 is not connected (NO at step S35), a connection process of the network is executed again. If the network 12 is connected (YES at step S35), UIM information, device information and abuse information are notified to the management server 6 (step S36), and the abuse information is registered (step S37).

As another process of abuse, the function suppression program 430 is executed in the portable terminal device 4. Function suppressing operation for suppressing a function of the portable terminal device 4 is executed by the CPU 410. The function suppression is function locking such as stop of an input function of the operation input unit 410, stop of a display function, stop of a function of the wireless communication unit 402 after notification of abuse information.

(Registration Process of Abuse Information)

As shown in FIG. 14, the management server 6 executes a loss information management program 610 if the abuse notification is received. The loss information management program 610 performs registration of loss report information, and reference to the registered device information and UIM information and the abuse information.

In a registration process of abuse information, as shown in FIG. 15, UIM information, device information and abuse information are read out (step S41). Location identification information of the base station 10 notified from the portable terminal device 4 is read out (step S42). Device information representative of the portable terminal device 4 that is in abuse, UIM information and location identification information are registered in the abuse information registration area 18 as abuse information (step S43).

After such registration of the abuse information, whether a notification destination in abuse has been registered is determined (step S44). If the registration is executed (YES at step S44), abuse notification is issued (step S45). Unless the notification destination has been registered (NO at step S44), such process is ended. Abuse notification is notified by e-mail, etc. to the other registered portable terminal device 400 as shown in FIG. 9.

(Process of Abuse Notification)

A process of abuse notification is executed on the basis of notification of a loss report of the portable terminal device 4 from the user 44 (FIG. 9). As shown in FIG. 16, when the above described loss report is notified from the user 44 to the management server 6 (step S51), the management server 6 receives the loss report (step S52) and executes a loss reception process (step S53). In the loss reception process, notification of a notification destination of abuse is issued from the user 44 (step S54), the notification destination of the abuse is received, is registered (step S55) and the abuse reception process is executed (step S56). If information on use representative of abuse is sent from the lost portable terminal device 4 (step S57), the management server 6 receives information on use concerning the abuse (step S58), and the registered notification destination is retrieved (step S59). If Registration of the notification destination exists (step S60), abuse information is sent to the notification destination (step S61). The user 44 receives abuse information by the other portable terminal device 400 (FIG. 9) (step S62) to enable to know the abuse and an area where the abuse is done from abuse information.

d. Function Suppression or Release Thereof of Portable Terminal Device

A function suppression or release thereof of the portable terminal device 4 is executed such that function suppression or release thereof about the portable terminal device 4 is instructed from the user 44 to the management server 6 (step S71). The instruction of the function suppression or release thereof is received in the management server 6 (step S72). The management server 6 instructs the function suppression or release thereof to the portable terminal device 4 (step S73). The instruction is received in the portable terminal device 4 (step S74), and a process of the function suppression or release thereof is executed (step S75). Whether the process is ended is determined (step S76). In case the process is ended (YES at step S76), the completion notification is issued (step S77). Unless process of the function suppression or release thereof is completed (NO at step S76), mis-process notification is issued (step S78). These notifications are notified to the management server 6. The management server 6 receives a result thereof (step S79) and sends the result notification to the user 44 (step S80). The user 44 receives the result notification of a state of the function suppression, release thereof or mis-process thereof to enable to know the state (step S81)

e. Process of Setting Modification of Portable Terminal Device 4 and UIM 8

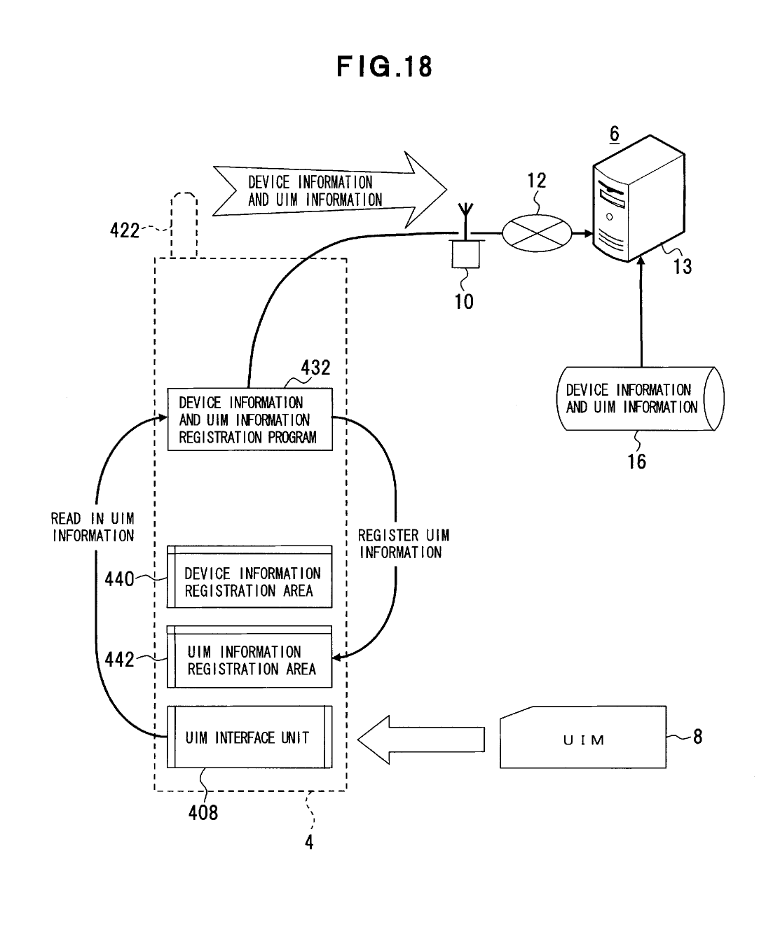

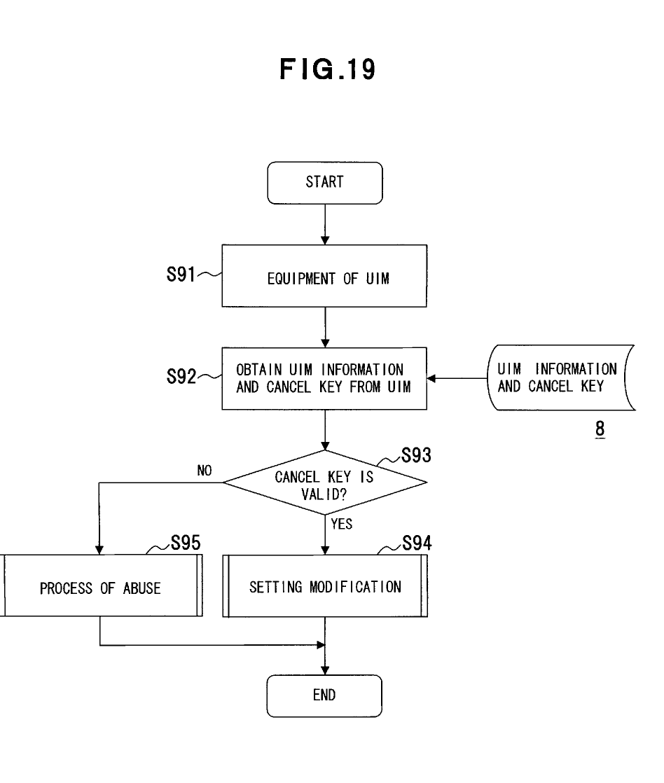

Setting modification of the portable terminal device 4 and UIM 8 will be described with reference to FIGS. 18 and 19. FIG. 18 depicts operation of setting modification and FIG. 19 is a flowchart showing operation of setting modification. Same reference numerals are used in FIG. 18 for the same constituents in FIGS. 1 and 2.

Device information, UIM information and valid UIM 8 are requested for this setting modification as shown in FIG. 18. The setting modification is executed by using the device information and UIM information registration program 432. If UIM information is modified, modification information is sent to the management server 6 and registration thereof is modified, too.

As shown in FIG. 19, in this setting modification, the portable terminal device 4 is equipped with the UIM 8 (FIG. 18) (step S91). UIM information and a cancel key are obtained from the equipped UIM 8 (step S92), and whether the cancel key is valid is determined. (step S93). That is, whether the cancel key obtained from the UIM 8 coincides with the cancel key registered at the portable terminal device 4 side is determined. If the cancel key is valid (YES at step S93), setting can be modified (step S94).

If the cancel key is invalid (No at step S93), a process of abuse (step S95) is executed, and the setting modification is prohibited. The process of abuse is as described above.

In the setting modification, modification can be done such that the conventional UIM 8 is substituted to new UIM 800, or a user is modified. If such setting modification is executed, the modification is notified to the management server 6, and UIM information with relation to device information is modified.

Features extracted from the above described first embodiment are listed as follows.

(1) In case that information except user information such as a UIM number registered by a user is used, it is configured that information can be notified to the management server 6 such as a cellar telephone career. If an abuser replaces the UIM 8 to communicate, device information of the portable terminal device 4, UIM information such as a user number and a utilization area are notified to the management server 6 to be registered.

(2) By inquiry from a valid user of the portable terminal device 4 to the management server 6, the user can know a utilization number and utilization area of an abuser.

(3) When UIM is replaced to UIM excepting the registered UIM, function suppression is operated, and the portable terminal device 4 cannot be used such as operation thereof. Even if UIM is replaced to the registered UIM again, the portable terminal device 4 can be protected from abuse because all the function suppression of the portable terminal device is effective as long as the function suppression is unreleased.

(4) A user of the portable terminal device 4 registers a using UIM number as an initial setting process. The setting can be modified only when a valid UIM is used.

(5) In case the portable terminal device 4 is lost and used with UIM replaced by the other party, information on use (device information of the portable terminal device, UIM information such as a user number and utilization area) is automatically notified to the management server 6.

(6) An owner (valid user) of the portable terminal device 4 reports loss to the management server 6. The management server 6 analyzes the loss report information and information notified from the lost portable terminal device. Thus, it is possible to identify a utilization area and a user.

### Second Embodiment

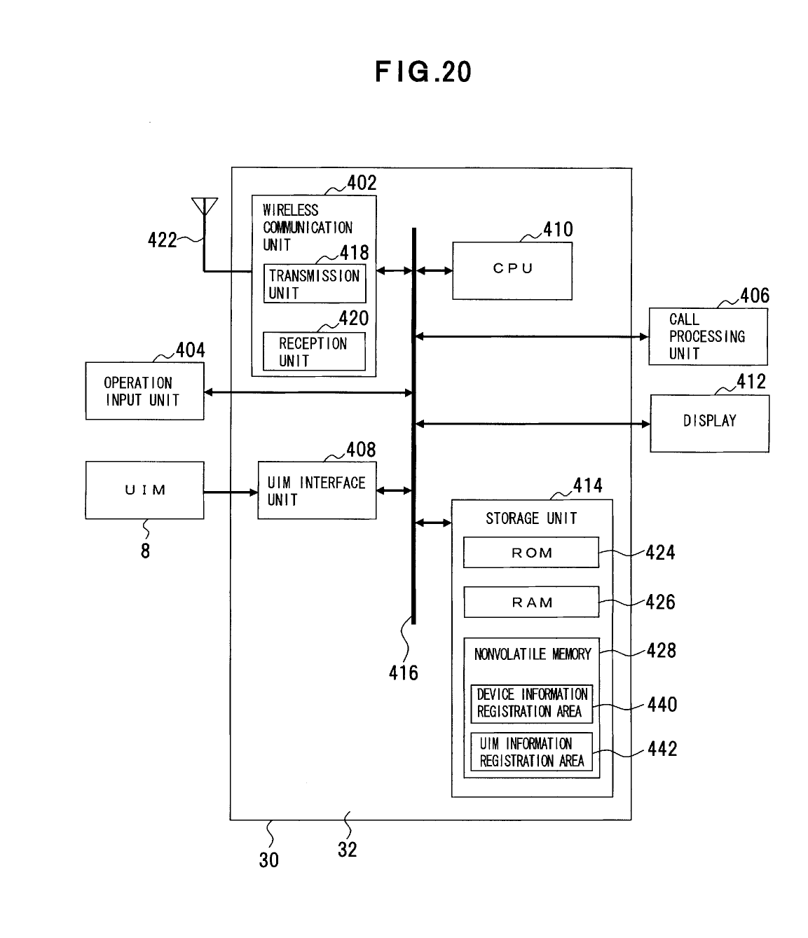

A second embodiment of the present invention will be described with reference to FIG. 20. FIG. 20 depicts an example of a circuit device of the present invention. The shown circuit device is one example, and does not limit the present invention. Same reference numerals are used in FIG. 20 for the same constituents in FIG. 2, and description thereof is omitted.

This circuit device 30 is used for a portable terminal device 4 for example, as a communication device able to communicate by equipment of a UIM 8. In the circuit device 30, a circuit board 32 composed of a multilayer circuit board, etc. is equipped with the above described wireless communication unit 402, UIM interface unit 408, CPU 410 and bus 416. The portable terminal device 4 can be configured by using the circuit device 30 of such structure, and the above described function can be realized.

In the circuit device 30 according to this embodiment, the UIM interface unit 408 is equipped on the circuit board 32. The UIM interface unit 408 may be separate structure from the circuit board 32. It may be configured that all or a part of the operation input unit 404, call processing unit 406 and display 412 are equipped on the circuit board 32.

### Other Embodiment

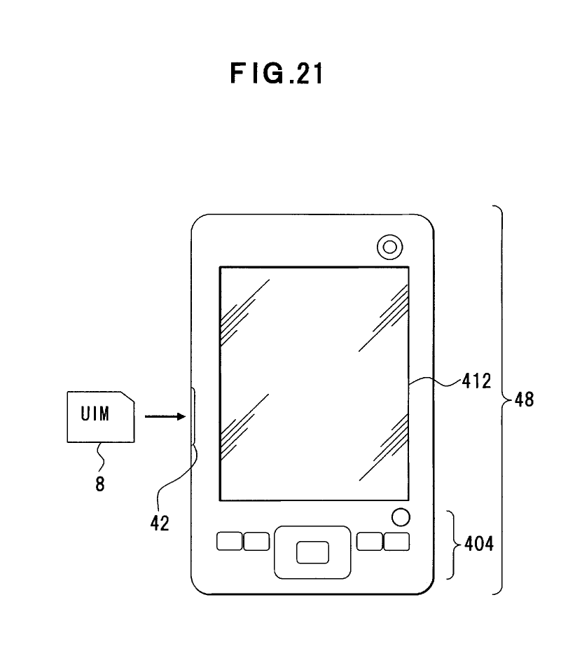

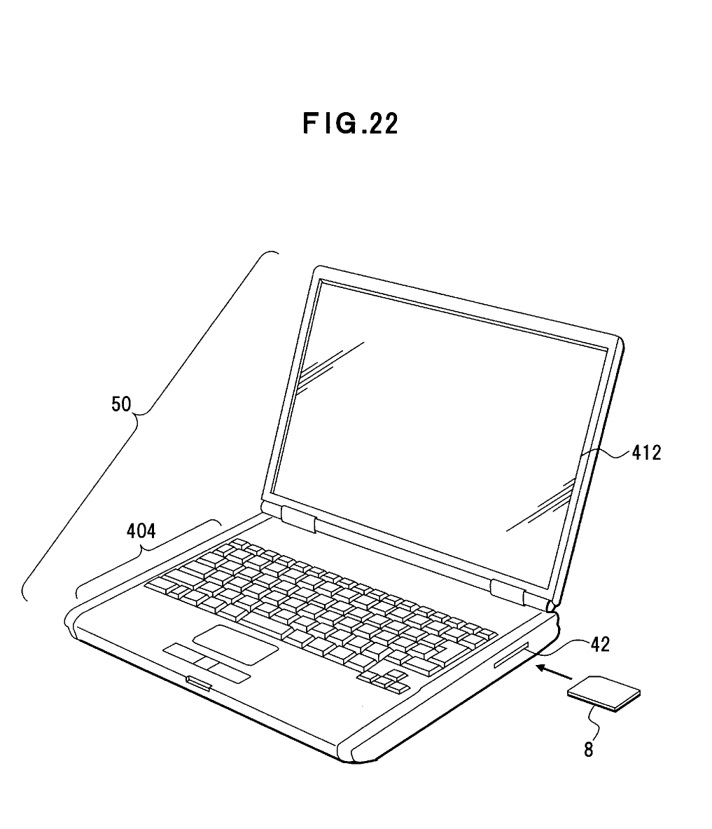

(1) In the above embodiments, the portable terminal device 4 is exemplified as a communication device. For example, as shown in FIG. 21, the present invention may be applied to a personal digital assistant (PDA) 48 that can communicate via the UIM 8. As shown in FIG. 22, the present invention may be applied to a personal computer (PC) 50 that can communicate via the UIM 8. In this case, the above described device information is composed of an identifying number such as a serial number added to the PDA 48 or PC 50. Like this, the same effects can be obtained if the present invention is applied to the communication device. Same reference numerals are used in FIGS. 21 and 22 for the same constituents in FIG. 3, and description thereof is omitted.

(2) The present invention may be applied to an electronic device having a communication function able to communicate via the UIM 8, and is not limited by the above embodiments.

### Other Inventive Matters

Technical ideas extracted from the above-mentioned embodiments are enumerated as follows.

(ADDITIONAL REMARK 1) A communication device that uses a recording medium storing specific user information, the communication device comprising:

a processing unit that acquires the user information from the recording medium;

a registration unit that registers the user information acquired by the processing unit by being related to device identification information identifying the communication device; and

a transmission unit that transmits the user information and the device identification information to a specific opposite party.

(ADDITIONAL REMARK 2) A communication device that uses a recording medium storing specific user information, the communication device comprising:

a registration unit that registers the user information acquired from the recording medium;

a determination unit that determines whether user information acquired from a recording medium and the user information in the registration unit coincide or not; and

a transmission unit that, if the determination unit determines that user information is different, transmits information on use of a recording medium storing different user information to a specific opposite party.

(ADDITIONAL REMARK 3) The communication device of ADDITIONAL REMARK 2, wherein

the information on use comprises one or a plurality of device identification information, user information in the registration unit, utilization area information or user information in a replaced recording medium.

(ADDITIONAL REMARK 4) The communication device of claim 1, comprising:

a reception unit that receives function suppression information notified from an outside; and

a processing unit that suppresses a function of the communication device in accordance with the function suppression information.

(ADDITIONAL REMARK 5) A communication device that uses a recording medium storing specific user information, the communication device comprising:

a registration unit that registers the user information acquired from the recording medium; and

a processing unit that permits modification of registered contents in the registration unit if user information acquired from a recording medium and the user information in the registration unit coincide.

(ADDITIONAL REMARK 6) A communication device that uses a recording medium storing specific user information, the communication device comprising:

a registration unit that registers the user information acquired from the recording medium; and

a processing unit that determines whether user information acquired from a recording medium and the user information in the registration unit coincide or not, and that, if user information is different, suppresses a function of the communication device.

(ADDITIONAL REMARK 7) A management method of a communication device that uses a recording medium storing specific user information, the method comprising:

acquiring user information from the recording medium;

registering the acquired user information in connection with device identification information of the communication device; and

transmitting the user information and the device identification information to a specific opposite party.

(ADDITIONAL REMARK 8) A management method of a communication device that uses a recording medium storing specific user information, the method comprising:

registering the user information acquired from the recording medium in a registration unit;

determining whether user information acquired from the recording medium and the user information in the registration unit coincide or not when the recording medium is equipped; and

transmitting, if it is determined that user information is different, information on use of a recording medium storing different user information to a specific opposite party.

(ADDITIONAL REMARK 9) A management method of a communication device that uses a recording medium storing specific user information, the method comprising:

registering the user information acquired from the recording medium in a registration unit;

determining whether user information acquired from the recording medium and the user information in the registration unit coincide or not when the recording medium is equipped; and

suppressing a function of the communication device if it is determined that user information is different.

(ADDITIONAL REMARK 10) A management program of a communication device that uses a recording medium storing specific user information and is executed by a computer, the program comprises the steps of:

acquiring the user information from the recording medium if the recording medium is equipped;

registering the acquired user information in connection with device identification information of the communication device; and

transmitting the user information and the device identification information to a specific opposite party.

(ADDITIONAL REMARK 11) A management program of a communication device that uses a recording medium storing specific user information and is executed by a computer, the program comprises the steps of:

registering the user information acquired from the recording medium in a registration unit;

determining whether user information acquired from a recording medium and the user information in the registration unit coincide or not; and

transmitting, if it is determined that user information is different, information on use of a recording medium storing different user information to a specific opposite party.

(ADDITIONAL REMARK 12) A management program of a communication device that uses a recording medium storing specific user information and is executed by a computer, the program comprises the steps of:

registering the user information acquired from the recording medium in a registration unit;

determining whether user information acquired from a recording medium and the user information in the registration unit coincide or not; and

suppressing a function of the communication device if it is determined that user information is different.

(ADDITIONAL REMARK 13) A recording medium that is used for a communication device, the recording medium comprising:

a recording unit storing device identification information obtained from the communication device.

(ADDITIONAL REMARK 14) A management apparatus of a communication device that uses a recording medium storing specific user information, the management apparatus comprising:

a communication unit that communicates with the communication device, and acquires device identification information identifying the communication device and the user information and;

a first registration unit that registers the device identification information and user information acquired in the communication unit.

(ADDITIONAL REMARK 15) The management apparatus of ADDITIONAL REMARK 14, wherein

by equipping with a recording medium storing user information different from the user information registered in the communication unit, information on use, which is notified from the communication device, is obtained, and the information on use is sent from the communication unit to a specific opposite party.

(ADDITIONAL REMARK 16) The management apparatus of ADDITIONAL REMARK 14, comprising:

a second registration unit that obtains and registers information on use, which is notified from the communication device able to communicate by equipping with a recording medium storing use information different from the user information registered in the communication unit, wherein

the information on use registered in the registration unit is sent toward a specific notification requester from the communication unit.

(ADDITIONAL REMARK 17) The management apparatus of the communication device of ADDITIONAL REMARK 15 or 16, wherein

the information on use comprises one or a plurality of device identification information, user information in the registration unit, utilization area information or user information in the replaced recording medium.

(ADDITIONAL REMARK 18) The management apparatus of the communication device of ADDITIONAL REMARK 14, wherein

function suppression information is sent from the communication unit to the communication device on the basis of a request from a specific request destination.

(ADDITIONAL REMARK 19) A management method of a communication device that uses a recording medium storing specific user information, the method comprising:

communicating with the communication device, and acquiring device identification information identifying the communication device and the user information and;

registering the acquired device identification information and user information.

(ADDITIONAL REMARK 20) The management method of the communication device of ADDITIONAL REMARK 19, comprising:

obtaining information on use, which is notified from the communication device by equipping with a recording medium storing user information different from the user information registered in the communication device; and

notifying the information on use to a specific opposite party.

(ADDITIONAL REMARK 21) The management method of the communication device of ADDITIONAL REMARK 19, comprising:

registering information on use, which is notified from the communication device able to communicate by equipping with a recording medium storing user information different from the user information registered in the communication device; and

notifying the information on use toward a specific notification requester.

(ADDITIONAL REMARK 22) The management method of the communication device of ADDITIONAL REMARK 19, wherein

function suppression information is sent toward the communication device on the basis of a request from a specific request destination.

(ADDITIONAL REMARK 23) A management program of a communication device that uses a recording medium storing specific user information and is executed by a computer, the program comprises the steps of:

communicating with the communication device, and acquiring device identification information identifying the communication device and the user information and;

registering the acquired device identification information and the user information.

(ADDITIONAL REMARK 24) The management program of the communication device of ADDITIONAL REMARK 23, comprising:

obtaining information on use, which is notified from the communication device using a recording medium storing user information different from the user information registered in the communication device, and sending the information on use to a specific opposite party.

(ADDITIONAL REMARK 25) The management program of a communication device of ADDITIONAL REMARK 23, comprising:

registering information on use, which is notified from the communication device using a recording medium storing user information different from the user information registered in the communication device; and

notifying the information on use toward a specific notification requester.

(ADDITIONAL REMARK 26) The management program of the communication device of ADDITIONAL REMARK 23, comprising:

sending function suppression information toward the communication device on the basis of a request from a specific request destination.

(ADDITIONAL REMARK 27) A communication management system that uses a recording medium storing specific user information, the system comprising:

a communication device that sends the user information acquired from the recording medium and device identification information identifying the communication device; and

a management server that obtains the user information and device identification information sent from the communication device to register them; wherein

the user information is related to the device identification information and managed.

(ADDITIONAL REMARK 28) A circuit device that uses a recording medium storing specific user information, the circuit device comprising:

a processing unit that acquires the user information from the recording medium;

a registration unit that relates the user information acquired by the processing unit to device identification information of a communication device and is registered; and

a transmission unit that transmits the user information and device identification information to a specific opposite party.

(ADDITIONAL REMARK 29) A circuit device that uses a recording medium storing specific user information, the circuit device comprising:

a registration unit that registers the user information acquired from the recording medium;

a determination unit that determines whether user information acquired from a recording medium and the user information in the registration unit coincide or not; and

a transmission unit that, if the determination unit determines that user information is different, transmits information on use of a recording medium storing different user information to a specific opposite party.

(ADDITIONAL REMARK 30) A circuit device that uses a recording medium storing specific user information, the circuit device comprising:

a registration unit that registers the user information acquired from the recording medium; and

a processing unit that permits modification of registered contents in the registration unit if user information acquired from a recording medium and the user information in the registration unit coincide.

(ADDITIONAL REMARK 31) A circuit device that uses a recording medium storing specific user information, the circuit device comprising:

a registration unit that registers the user information acquired from the recording medium; and

a processing unit that determines whether user information acquired from a recording medium and the user information in the registration unit coincide or not, and if user information is different, suppresses a function of the communication device.

While the present invention has been described with the preferred embodiments, the description is not intended to limit the present invention. Various modifications of the embodiments based on the subject matters and objects described in claims or disclosed in this specification will be apparent to those skilled in the techniques, and such modifications rightfully fall within the true scope of the present invention.

The present invention relates to a communication device such as a portable terminal device able to communicate by equipment of a recording medium that records subscriber information. The present invention is useful for using prevention from abuse and identification of an area in abuse, etc.

What is claimed is:

1. A communication device that uses a recording medium storing specific user information, the communication device comprising:
a processing unit that acquires the user information from the recording medium;
a registration unit that registers the user information acquired by the processing unit by being related to device identification information identifying the communication device; and
a transmission unit that transmits the user information and the device identification information to a specific opposite party.

2. A communication device that uses a recording medium storing specific user information, the communication device comprising:
a registration unit that registers the user information acquired from the recording medium;
a determination unit that determines whether user information acquired from a recording medium and the user information in the registration unit coincide or not; and
a transmission unit that, if the determination unit determines that user information is different, transmits information on use of a recording medium storing different user information to a specific opposite party.

3. A management apparatus of a communication device that uses a recording medium storing specific user information, the management apparatus comprising:
a communication unit that communicates with the communication device, and acquires device identification information identifying the communication device and the user information and;
a first registration unit that registers the device identification information and user information acquired in the communication unit.

4. The management apparatus of claim 3, wherein
by equipping with a recording medium storing user information different from the user information registered in the communication unit, information on use, which is notified from the communication device, is obtained, and the information on use is sent from the communication unit to a specific opposite party.

5. The management apparatus of claim 3, comprising:
a second registration unit that obtains and registers information on use, which is notified from the communication device able to communicate by equipping with a recording medium storing use information different from the user information registered in the communication unit, wherein
the information on use registered in the registration unit is sent toward a specific notification requester from the communication unit.

6. The management apparatus of the communication device of claim 4 or 5, wherein
the information on use comprises one or a plurality of device identification information, user information in the registration unit, utilization area information or user information in the replaced recording medium.

7. The management apparatus of the communication device of claim 3, wherein
function suppression information is sent from the communication unit to the communication device on the basis of a request from a specific request destination.
